(19) United States
(12) Patent Application Publication
(10) Pub. No.: US 2020/0365322 A1
(43) Pub. Date: Nov. 19, 2020

(54) DIELECTRIC CERAMIC MATERIAL COMPOSITION FOR CAPACITOR

(71) Applicant: HOLY STONE ENTERPRISE CO., LTD., Taipei (TW)

(72) Inventors: Jian-Hua LI, Taipei (TW); Sea-Fue WANG, Taipei (TW); Yuan-Cheng LAI, Taoyuan (TW)

(21) Appl. No.: 16/410,356

(22) Filed: May 13, 2019

(51) Int. Cl. H01G 4/12; H01G 4/30; C04B 35/468

(52) U.S. Cl. CPC H01G 4/12; H01G 4/30; C04B 2235/3215; C04B 2235/3206; C04B 35/468

(57) ABSTRACT

A dielectric ceramic material composition for a capacitor, which can be particularly a multilayer ceramic capacitor manufactured by a base-metal-electrode process, is provided. The dielectric ceramic material composition includes a main component BaTiO₃ and at least one sub-component Sc₂O₃. BaTiO₃ can be modified by controlling an addition amount of Sc₂O₃, and during the sintering reaction process, the addition of Sc₂O₃ can cause BaTiO₃ to form a core-shell structure, thereby inhibiting grain growth of BaTiO₃ and effectively improving insulation characteristic and capacitance temperature characteristic, and the stability to DC bias electric field. In an embodiment, MgO can be appropriately added to improve the stability of the TCC curve within an interval of −55° C. to 25° C. Therefore, the production process can be simplified and the usage amount of Sc₂O₃ can be reduced, thereby obtaining the dielectric ceramic material satisfying X8R characteristics regulated by EIA, at a low cost.

### BACKGROUND OF THE INVENTION

### 1. Field of the Invention

The present invention relates to a dielectric ceramic material which satisfies X8R characteristics regulated by EIA and can be applied to a base-metal-electrode process. More particularly, during preparation of the dielectric ceramic material of the present invention, BaTiO₃ is modified by controlling an addition amount of Sc₂O₃, so that BaTiO₃ forms a core-shell structure to improve stability of dielectric characteristic thereof to temperature and DC bias electric field, thereby reducing a usage amount of Sc₂O₃ and production cost, and providing high industrial applicability.

### 2. Description of the Related Art

With the advancement and rapid development of technology, capacitors have development trend towards miniaturization, high capacitance, high stability and reliability, therefore, conventional capacitors are gradually transferred to chip-type multilayer ceramic capacitors (MLCCs). Because of having reduced size, more capacitance, and lower production cost, the chip-type multilayer ceramic capacitors are most used and widely applied electronic components. The Electronic Industries Association of America (EIA) generalizes capacitors, according to the range of use and electrical characteristics, into two categories including temperature-compensated capacitor and medium-high dielectric capacitor. The multilayer ceramic capacitors regulated by X7R (−55° C. to 125° C., ΔC/C≤±15%) have a variety of electrical characteristics and can satisfy application temperature ranges of most consumer electronics, so they are widely used in various types of the electronic products. In recent years, the applications of automotive electronic products are developed rapidly and the safety requirements thereof becomes stricter, so the multilayer ceramic capacitors regulated by X7R are unable to cope with such harsh operating environment. In consideration of safety, high-level multilayer ceramic capacitors regulated by X8R (−55° C. to 150° C., ΔC/C≤±15%) and having higher temperature stability have high attention in the industry.

Furthermore, the technology in the capacitor filed are fully developed and the parts of the capacitor structure that can be changed are limited, so most researches and developments are directed to the composition proportion of the dielectric ceramic material and adjustment in dielectric properties of the dielectric ceramic material, so as to achieve the high dielectric constant characteristics and satisfy X8R characteristics regulated by EIA. The general process of manufacturing the multilayer ceramic capacitor can be divided, by materials of inner electrodes, into a noble-metal process and a base-metal process. In the noble-metal process, the inner electrodes are often formed by silver/palladium alloy. The cost of rare metals makes the related products extremely costly, so most multilayer ceramic capacitors are manufactured by cheaper base-metal process under cost considerations. In the base metal electrode process, the material of the inner electrode is copper (Cu) or nickel (Ni) which is easily oxidized, so the material of the inner electrode must be sintered under a reduction atmosphere. However, sintering process under the reduction atmosphere causes deoxidation of the dielectric ceramic material, and it deteriorates the insulation characteristic of the multilayer ceramic capacitor. Therefore, the formulation of stable dielectric ceramic material is not easily achieved.

In addition, in the development of the multilayer ceramic capacitor satisfying the X8R characteristics regulated by EIA, the barium titanate ceramic substrate having a higher dielectric constant is use as main component, and various modifiers, grain growth inhibitors, sintering aid are added into barium titanate for modification, so as to improve the dielectric characteristic stability and sinterability of the dielectric ceramic material. A conventional technology discloses a method for preparing a dielectric ceramic mixture. For example, Republic of China invention publication No. TW201044427A, uses BaTiO₃ as the main component and uses different contents of Sc₂O₃, MgCO₃, BaSiO₃, MnCO₃, La₂O₃, Co₃O₄ and NiO as additive components to uniformly mix with BaTiO₃, so as to prepare the dielectric ceramic having high compactness and satisfying X8R characteristics regulated by EIA. However, in order to achieve the stability of the dielectric properties regulated in the X8R characteristics, the dielectric ceramic must be added with a considerable proportion (such as, higher than 1.00 mol % but less than 4.00 mol %) of expensive Sc₂O₃, and it causes excessive high production cost, so such preparation method is less industrially usable. In order to reduce the content of Sc₂O₃ and achieve stable dielectric characteristic, other oxides (such as La₂O₃, Co₃O₄ or NiO) must be added in BaTiO₃, and it increases complexity of the material formulation composition, material control and production costs, and further the risk of manufacturing variation. Furthermore, in order to satisfy X8R characteristics regulated by EIA, some conventional technologies add different main components, or add complex sub-components to modify the primary component, to make the temperature coefficient of capacitance (TCC) curve near the Curie temperature or within the high temperature interval of 25° C. to 150° C. gradually flat, but it also causes low-temperature interval of the TCC curve, such as at room temperature or within the interval of −55° C. to 25° C., to be abnormally steep or excessively varied, and excellent flatness of the TCC curve below the room temperature is severely degraded. In other words, such modification gains in one thing and lose in another, and it is the problems caused difficult control of manufacturing variation. Therefore, it is still necessary to solve this key issue in the industry.

### SUMMARY OF THE INVENTION

In order to solve the problem that the conventional manner of preparing dielectric ceramic by adding a considerable content of expensive Sc₂O₃ to modify BaTiO₃ may cause an excessive production cost and is not commercially competitive, and the problem that the complexity of the material composition, the production cost and the risk of manufacturing variation are greatly increased when the content of Sc₂O₃ is reduced and additional compounds such as La₂O₃, Co₃O₄ and NiO are added, the inventors develop a dielectric ceramic material composition applied to a base-metal-electrode process according to collected data, multiple tests, and years of research experience.

An objective of the present invention is to modify BaTiO₃ by controlling an addition amount of Sc₂O₃ in preparation of the multilayer ceramic capacitor of an embodiment, and during a sintering reaction process, the addition content of the Sc₂O₃ can cause BaTiO₃ to form a core-shell structure which can inhibit grain growth of BaTiO₃, so as to effectively improve insulation characteristic and dielectric temperature stability of BaTiO₃. The addition content of Sc₂O₃ per 100 mol of BaTiO₃ is in range of 0.30 mol to 1.00 mol, and 0 mol to 2.00 mol of MgO can be added to improve stability of a TCC curve within an interval of −55° C. to 25° C. Since the additive component of the material composition of the present invention is simple and the content of additive component is scarce, the usage amount of Sc₂O₃, the production cost and risk of manufacturing variation can be reduced, thereby obtaining the dielectric ceramic material which can be applied to the base-metal-electrode process and satisfy the X8R characteristics regulated by EIA.

The another objective of the present invention is that the dielectric ceramic material used in the multilayer ceramic capacitor is preferably BaTiO₃ doped with 0.45 mol % Sc₂O₃ and 1.00 mol % MgO, and a variation rate of the dielectric constant of the dielectric ceramic material in the interval of −55° C. to 150° C. can be stable within ±10%, so that the dielectric ceramic material can satisfy the X8R characteristics regulated by EIA and be applied to the base-metal-electrode process, wherein the dielectric constant is 1744, the dielectric loss is 0.58%, the TCC at −55° C. is −3.9% and the TCC at 150° C. is −8.5%, and the resistivity at a room temperature can reach 2.8×10¹² Ω-cm, and the resistivity at a high temperature 150° C. can reach 1.7×10¹¹ Ω-cm. Therefore, the stability of the dielectric temperature characteristics of the multilayer ceramic capacitor can be effectively improved, and the multilayer ceramic capacitor can have good insulation characteristic.

### BRIEF DESCRIPTION OF THE DRAWINGS

The structure, operating principle and effects of the present invention will be described in detail by way of various embodiments which are illustrated in the accompanying drawings.

FIG. 1 is a flowchart of preparing a multilayer ceramic capacitor by using dielectric ceramic material, according to an embodiment of the present invention.

FIG. 2 is a first data table of composition proportions and characteristics of the dielectric ceramic material according to an embodiment of the present invention.

FIG. 3 is a first diagram showing measured data of dielectric temperature characteristic according to an embodiment of the present invention.

FIG. 4 is a second data table of composition proportions and dielectric characteristics of the dielectric ceramic material according to an embodiment of the present invention.

FIG. 5 is a second diagram showing measured data of dielectric temperature characteristic according to an embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

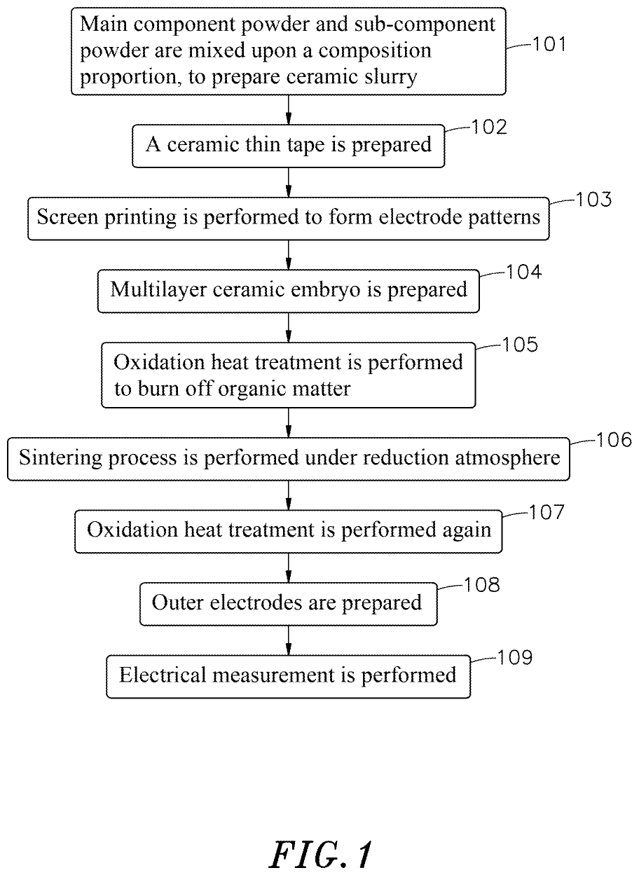

Please refer to FIG. 1, which shows a flowchart of preparing a multilayer ceramic capacitor by using dielectric ceramic material according to an embodiment of the present invention. As shown in FIG. 1, the method of preparing the multilayer ceramic capacitor according to the embodiment of the present invention can be implemented by following steps 101 to 109, but the present invention is not limited to this example, and any method of preparing the multilayer ceramic capacitor well known to those skilled in the art can be used in the present invention, and other types of products applying the ceramic capacitor are also included the present invention. The method of preparing the multilayer ceramic capacitor includes the steps 101 to 109.

In a step 101, main component powder and sub-component powder are mixed upon a composition proportion, to prepare ceramic slurry.

In a step 102, a ceramic thin tape is prepared.

In a step 103, screen printing is performed to form electrode patterns.

In a step 104, multilayer ceramic embryo is prepared.

In a step 105, an oxidation heat treatment is performed to burn off organic matter.

In a step 106, a sintering process is performed under reduction atmosphere.

In a step 107, the oxidation heat treatment is performed again.

In a step 108, outer electrodes are prepared.

In a step 109, electrical measurement is performed.

According to above-mentioned implementation steps, the high-purity (>99%) BaTiO₃ powder is heated to 1150° C. in air by a heating rate of 5° C./min for 4 hours, the heated BaTiO₃ powder is used as the initial BaTiO₃ powder. Next, the main component including BaTiO₃ powder, 0.05 mol % manganese carbonate (MnCO₃), 1.37 mol % barium silicate (BaSiO₃), and at least one sub-component including 0.30˜1.00 mol % scandium oxide (Sc₂O₃), and 0˜2.00 mol % magnesium oxide (MgO), are mixed upon a composition formula. Next, toluene, waterfree alcohol, binder, dispersant and plasticizer are added in the above-mentioned mixture and zirconia balls are used to grind for uniformly mixing, so as to prepare the ceramic slurry. Next, the ceramic slurry is shaped to form the ceramic thin tape by using scraper, and the screen printing process is then performed to form metal electrode patterns including nickel (Ni), copper (Cu), silver (Ag) or palladium (Pd), on the ceramic thin tape. The ceramic thin tape is then stacked in a staggered manner, and a thermocompression process is performed on the stacked ceramic thin tape to form the compact multilayer ceramic embryo. Next, the compact multilayer ceramic embryo can be cut according to a designed size of the multilayer ceramic capacitor.

Before the sintering process, the oxidation heat treatment is performed on the multilayer ceramic embryo at 350° C. to 550° C. for 4 hours under a pure nitrogen (N₂) atmosphere, and heating and cooling rates are maintained at 2° C./min, thereby burning off the previously-added organic matter in the multilayer ceramic embryo, and the multilayer ceramic embryo is then sintered at 1200° C.˜1300° C. for 2 hours under the reduction atmosphere composed of 97% pure nitrogen, 3% hydrogen (H₂), and 35° C. saturated vapor, wherein heating and cooling rates are maintained at 5° C./min. Next, the oxidation heat treatment is performed on the sintered samples at 950° C. for 2 hours under low oxygen partial pressure atmosphere composed of pure nitrogen and 35° C. saturated vapor. After the heated sample is slowly cooled to room temperature, the mature multilayer ceramic embryo can be obtained.

Next, two ends of the mature multilayer ceramic embryo are coated by immersing into Cu electrode coating, to form the outer electrodes in contact with the inner Ni electrodes. The outer electrodes are sintered at 900° C. under the pure nitrogen atmosphere, to combine with the inner Ni electrodes. Next, Ni and Sn are plated on the Cu electrodes at the two ends of the semi-finished multilayer ceramic capacitor. As a result, preparation of all samples of the embodiments of the present invention is completed. After the preparation of the samples is completed, the microstructure of the multilayer ceramic capacitor can be observed by using a scanning electron microscope (SEM), a transmission electron microscope (TEM) and an X-ray diffractometer (XRD). The resistance-capacitance inductance (TLC) measuring instrument can be used to measure dielectric characteristic of the multilayer ceramic capacitor.

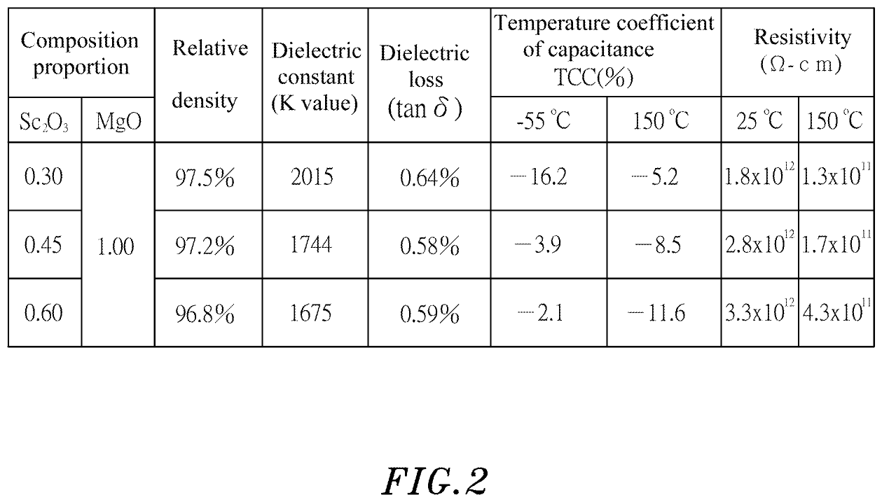

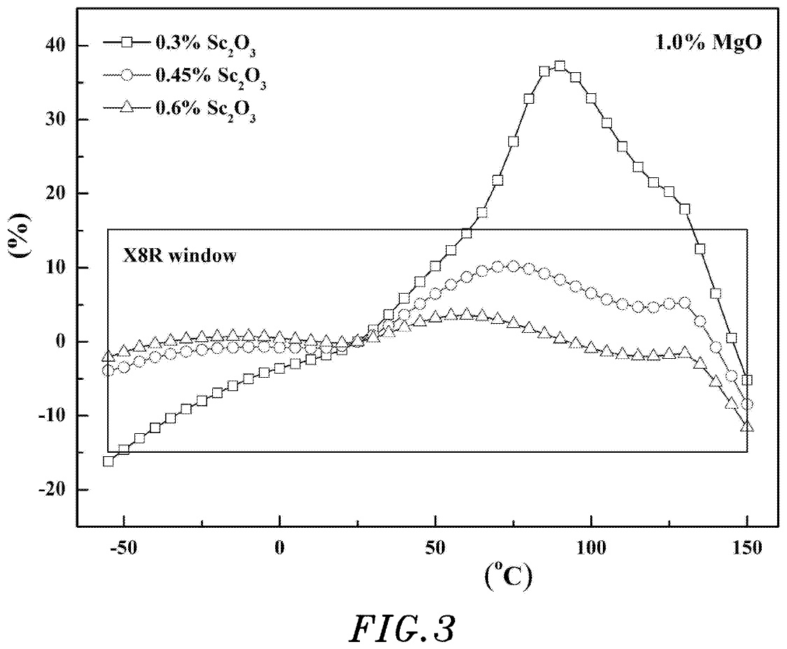

Please refer to FIGS. 2 and 3, which are a first data table showing composition proportion and dielectric characteristic of the dielectric ceramic material of an embodiment of the present invention, respectively, and a first diagram showing measured data of dielectric temperature characteristic of an embodiment according to the present invention. As shown in FIGS. 2 and 3, the dielectric ceramic material, used to manufacture the multilayer ceramic capacitor of the present invention, mainly includes BaTiO₃, 0.05 mol % MnCO₃, and 1.37 mol % BaSiO₃ as main components; however, in practical application, other compounds can be appropriately added to mix with BaTiO₃. The main components can be further added with sub-components including different contents of Sc₂O₃ (0.30˜0.60 mol %) and MgO (0˜2.00 mol %), for modifying BaTiO₃.

According to observation results of using the SEM to observe cross-sectional microstructure of the multilayer ceramic capacitor of each embodiment of the present invention, the multilayer ceramic capacitor formed by adding 0.30 mol % Sc₂O₃ has less apertures and higher sinter density than the multilayer ceramic capacitor formed by adding 0.60 mol % Sc₂O₃. As the addition amount of Sc₂O₃ increases, the grain sizes of BaTiO₃ become tinier and particle sizes of BaTiO₃ are more uniform, but during the sintering process Sc₂O₃ tends to inhibit the grain boundary migration rate of BaTiO₃. As a result, excessive addition of Sc₂O₃ results in a decrease in the compactness of BaTiO₃ and an increase of the sintering dense temperature. Furthermore, because of the grain size reduction of BaTiO₃, the increase of the addition amount of Sc₂O₃ makes the dielectric constant and dielectric loss of BaTiO₃ lower, and the insulation characteristic is significantly improved because of the increase of grain BET surface area. Furthermore, according to the changes of the TCC corresponding to the addition amount of Sc₂O₃ changed from 0.30 mol % to 0.60 mol %, it can be found that the increase of the addition amount of Sc₂O₃ is significantly beneficial to the stability of the TCC curve of BaTiO₃.

The effect of different addition amount of Sc₂O₃ for the crystal structure and dielectric characteristic of BaTiO₃ in the microstructure of multilayer ceramic capacitor is described in following paragraphs. The observation result of using the TEM shows that when the addition amount of Sc₂O₃ is increased to 0.45 mol % or more, the grain of BaTiO₃ forms a core-shell structure with uneven chemical compositions. According to the analysis for the compositions of the grain by using the energy dispersive X-Ray spectroscopy (EDS), it can be found that the grain shell has a higher content of scandium (Sc) (for example, higher than 1.0 at %) and the grain core has a lower content of Sc element (for example, lower than 0.5 at %), and the phenomenon is due to the difference in concentration gradient caused by the lower diffusion rate of Sc. The higher content of Sc causes that the core-shell structure having a concentration gradient can be formed on the grain of BaTiO₃. The grain shell is less tetragonal and has a paraelectric state of the approximate cubic crystal structure, and grain core is more tetragonal and has a spontaneously polarized ferroelectric tetragonal structure. Furthermore, the diffusion rate of Mg is relatively fast, so contents of Mg in the grain shell and the grain core are not different greatly. However, when the addition amount of Sc₂O₃ reaches 0.30 mol %, the core-shell structure with the uneven chemical composition is not found in the crystal grain.

As shown in FIGS. 2 and 3, the dielectric characteristics of the capacitors added with different contents of Sc₂O₃ and MgO and sintered in the reduction atmosphere are listed and temperature coefficient of capacitance (TCC) versus temperature curves are provided, respectively. As shown in FIGS. 2 and 3, when the content of Sc₂O₃ added with BaTiO₃ is increased from 0.30 mol %, the TCC curve within the interval of −55° C. to 150° C. can become flatter, more particularly for the multilayer ceramic capacitors added with 0.45 mol % and 0.60 mol % of Sc₂O₃. When the addition amount of MgO is 1.00 mol %, the stability of the TCC curve within the interval of −55° C. to 25° C. interval is improved. As a result, the addition of Sc₂O₃ can provide a good effect of stabilizing the dielectric temperature characteristics of BaTiO₃, especially for the TCC curve within the interval of 25° C. to 150° C.

As shown in FIGS. 2 and 3, when the addition amounts of Sc₂O₃ are 0.45 mol % and 0.60 mol %, dielectric constants are 1744 and 1675, the dielectric losses (tan δ) are 0.58% and 0.59%, the TCCs at −55° C. are −3.9% and −2.1%, TCCs at 150° C. are −8.5% and −11.6%, the resistivity at room temperature 25° C. can reach 2.8×10¹² Ω-cm and 3.3×10¹² Ω-cm, and the resistivity at high-temperature 150° C. can reach 1.7×10¹¹ Ω-cm and 4.3×10¹¹ Ω-cm, respectively. As a result, all TCC curves corresponding to relevant composition proportions can satisfy the X8R characteristics regulated by EIA, and the material composition of the present invention also has good insulation characteristic.

In an preferred embodiment, the dielectric ceramic material used for multilayer ceramic capacitor is doped with 0.45 mol % Sc₂O₃ and 1.00 mol % MgO, and such dielectric ceramic material has the best dielectric characteristic, and a variation rate of the dielectric constant (K value) of the dielectric ceramic material at a temperature of −55° C. to 150° C. can be stable within ±10%, which satisfies the X8R characteristics regulated by EIA, wherein the dielectric constant is 1744, the dielectric loss (tan δ) is 0.58%, the TCC at −55° C. is −3.9%, and the TCC at 150° C. is −8.5%, the resistivity at room temperature 25° C. reaches 2.8×10¹² Ω-cm, and the resistivity at high temperature 150° C. reaches 1.7×10¹¹ Ω-cm. Furthermore, in the process of manufacturing the multilayer ceramic capacitor of the embodiment of the present invention, the BaTiO₃ substrate can be modified by controlling the addition amount of Sc₂O₃, to make BaTiO₃ grains have the core-shell structure, and addition of Sc₂O₃ has the effect of inhibiting grain growth of BaTiO₃ during the sintering reaction process, so as to effectively improve the insulation characteristic. Furthermore, the addition amount of Sc₂O₃ is very tiny and not more than 1.00 mol %, the composition of the material composition is simple and the proportion of the additive component is scarce, so the production process can be simplified, and the usage amount of Sc₂O₃ can be reduced. As a result, the dielectric ceramic material composition of the present invention can be applied to the base-metal-electrode process at a low cost and satisfy the X8R characteristics regulated by EIA.

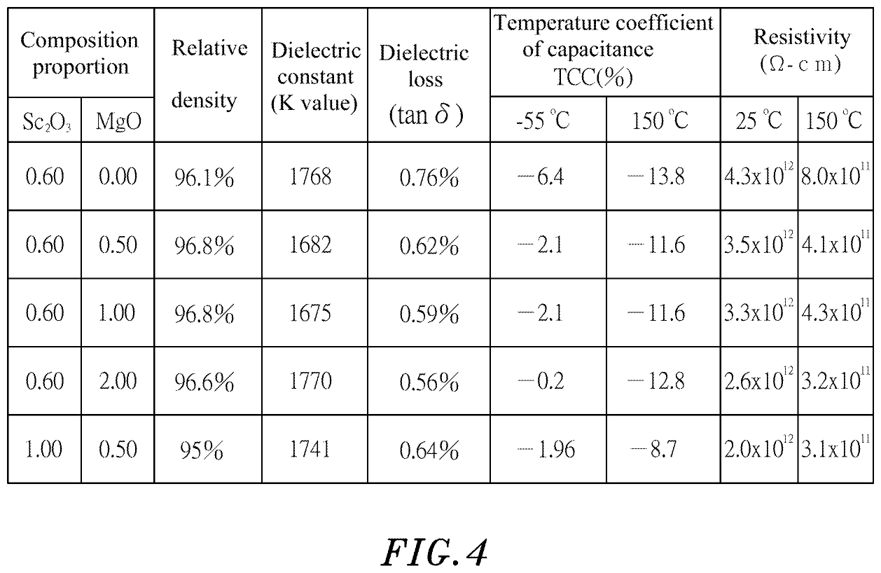

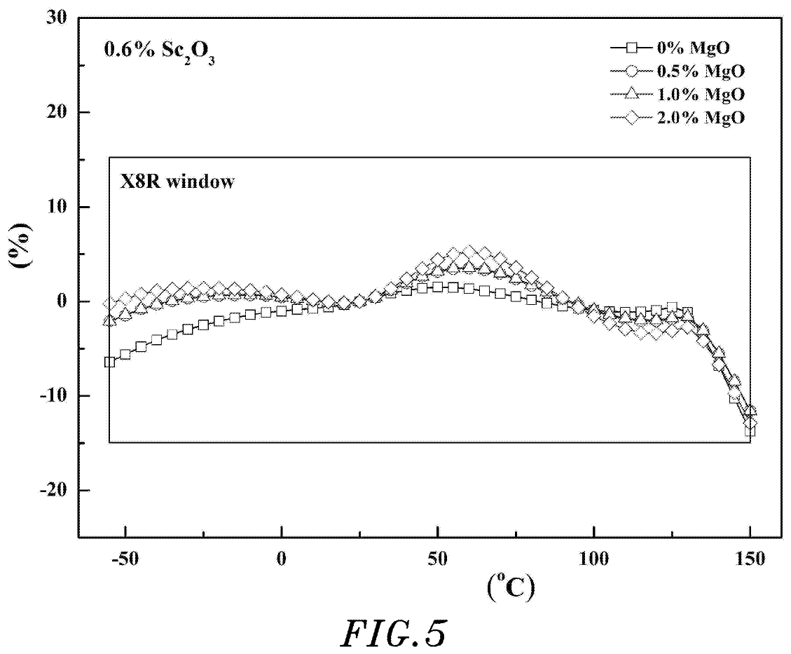

Please also refer to FIGS. 4 and 5, which are a second data table of the composition proportions and dielectric characteristics of the dielectric ceramic material used in the embodiment of the present invention, and a second diagram showing the dielectric temperature characteristic of the embodiment, respectively. As shown in FIGS. 4 and 5, when the addition amount of Sc₂O₃ is in range of 0.60 mol % to 1.00 mol %, the multilayer ceramic capacitor added with 0 mol % MgO still can have the TCC curves corresponding to relevant compositions and satisfying X8R characteristics regulated by EIA. Since the addition of 0.45 mol % or more Sc₂O₃ can cause BaTiO₃ grain to form the core-shell structure, the peak of TCC curve at a temperature ranging from −55° C. to 150° C. can be effectively suppressed. The addition of MgO has an effect of enhancing stabilization of the TCC curve within the interval of −55° C. to 25° C. When the addition amount of MgO is in a range of 0.50 mol % to 2.00 mol %, the addition of MgO causes the effect with same trend. The dielectric loss (tan δ) of the multilayer ceramic capacitor is rapidly dropped from 0.76% when the addition amount of MgO is 0 mol %, to 0.56% when the addition amount of MgO is 2.00 mol %. Obviously, the addition of Sc₂O₃ is critical for the stability of dielectric temperature characteristics (such as the dielectric constant and the TCC curve) of the multilayer ceramic capacitor. The addition of MgO is beneficial to enhance compactness of BaTiO₃ and reduce dielectric loss, and increase the TCC value at low temperature −55° C., for example, the TCC value is increased from −2.1% to −0.2%. More particularly, when the addition amount of Sc₂O₃ is 0.60 mol % or more, the effect of different content of MgO on the TCC curve becomes non-obvious, and it also indicates that the addition of Sc₂O₃ can improve the stability of the dielectric characteristic of BaTiO₃ to temperature, and also improve the stability of BaTiO₃ to chemical composition. Obviously, the content of the present invention is extremely valuable for industrial applicability.

In order to solve the convention problem that the preparation of the dielectric ceramic has various difficulty in adding Sc₂O₃ for modifying BaTiO₃ and especially in adding other compounds such as La₂O₃, Co₃O₄ or NiO, and the convention problem that addition of the other compounds causes manufacturing variation, the inventors use a tiny amount of Sc₂O₃ (0.3˜1.00 mol %) and MgO (0˜2.0 mol %) to effectively control the micro-diffusion in the crystal lattice, so as to simplify the production process and finally satisfy requirements defined in X8R characteristics regulated by EIA. When the addition amount of Sc₂O₃ is in a range of 0.45 mol % to 1.00 mol %, BaTiO₃ grain can form the core-shell structure with a concentration gradient, and have the stable dielectric characteristic. For example, when the content of Sc₂O₃ is 0.60 mol %, the TCC curves corresponding to different addition amounts of MgO almost overlap within the interval of −55° C. to 150° C.; furthermore, the low-temperature part (−55° C. to 25° C.) or high-temperature part (25° C. to 150° C.) of each of the TCC curves is very smooth. However, when the addition amount of Sc₂O₃ is less than 0.45 mol %, BaTiO₃ grain does not form the core-shell structure with the concentration gradient, so it is necessary to skillfully control the composition proportion of Sc₂O₃ and MgO, to make the dielectric ceramic satisfy the X8R characteristics regulated by EIA. For example, when the content of Sc₂O₃ is 0.30 mol %, the addition of MgO has a stabilizing effect on the TCC curve within the interval of −55° C. to 25° C., so that dielectric ceramic can satisfy to the X8R characteristics regulated by EIA, and the dielectric ceramic has a dielectric constant superior to other dielectric ceramic having the core-shell structure with concentration gradient. Furthermore, the present invention is not limited to the experimental values shown in figures or data tables disclosed above, and in particular, those skilled in the art can extrapolate the relationship between the data values obtained by the present invention, to further calculate, through statistical logic or trend derivation, some specific test values not described in the present invention, but the effect and modification do not depart from the spirit and scope of the disclosure set forth in the claims. For example, through extrapolation manner, it can be found that the same effect can be obtained when the tiny amount of Sc₂O₃ is decreased to 0.05 mol %. The present invention does not propose the specific test values and explain the experimental values in detail, but any result obtained by controlling the contents of Sc₂O₃ or MgO disclosed in the present invention and further using common scientific methods, such as interpolation, does not depart from the spirit and scope of the disclosure set forth in the claims.

According to above-mentioned contents, compared with conventional dielectric ceramic material, the dielectric ceramic material of the present invention has following advantages.

First, the dielectric ceramic material of the multilayer ceramic capacitor of the embodiment of the present invention includes BaSiO₃ as main component, and different content of Sc₂O₃ (such as 0.30˜1.00 mol %) as sub-component for modifying BaTiO₃; during the sintering reaction process Sc₂O₃ can make the grain size of BaTiO₃ smaller and make particle sizes of BaTiO₃ more uniform, and the addition of Sc₂O₃ also has the effect of inhibiting grain growth of BaTiO₃ and effectively improving insulation characteristic; when the content of Sc₂O₃ reaches 0.45 mol % or more, BaTiO₃ grain can form the core-shell structure having the concentration gradient, so as to greatly improve the stability of the TCC curve of BaTiO₃ within the interval of −55° C. to 150° C., and all TCC curves corresponding to relevant compositions can satisfy the X8R characteristics regulated by EIA.

Secondly, according to the dielectric ceramic material of the multilayer ceramic capacitor of the present invention, BaSiO₃ can be modified by adding different content of Sc₂O₃ in BaSiO₃, and the appropriate addition of MgO (0 to 2.00 mol %) in BaSiO₃ also can enhance the stability of the TCC curve within the interval of −55° C. to 25° C. The composition proportion of the dielectric ceramic material is simple and the proportion of additive component is scarce, so that the usage amount of Sc₂O₃ can be reduced and the usage of La₂O₃, Co₃O₄ and NiO can be omitted, thereby effectively reducing the complexity of the compositions of the material formula, the production cost, and the risk of manufacturing variation. As a result, the dielectric ceramic material of the present invention can be applied to the base-metal-electrode process and satisfy the X8R characteristics regulated by EIA.

Thirdly, the dielectric ceramic material disclosed in the present invention can preferably be BaTiO₃ doped with 0.45 mol % Sc₂O₃ and 1.00 mol % MgO, and the dielectric constant is 1744, the dielectric loss is 0.58%, the TCC at −55° C. is −3.9% and the TCC at 150° C. is −8.5%, and the resistivity at room temperature reaches 2.8×10¹² Ω-cm and the resistivity at high temperature 150° C. reaches 1.7×10¹¹ Ω-cm. Obviously, the stability of the dielectric temperature characteristics of the multilayer ceramic capacitor can be effectively improved.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A dielectric ceramic material composition applied to capacitor, and the dielectric ceramic material composition comprising:
a main component comprising BaTiO₃; and
a sub-component Sc₂O₃, wherein a content of the sub-component Sc₂O₃ per 100 mol of the main component BaTiO₃ is in range of 0.05 mol to 1.00 mol, and a TCC curve of the dielectric ceramic material composition formed by sintering the sub-component Sc₂O₃ and the main component BaTiO₃ satisfies X8R characteristics regulated by EIA.

2. The dielectric ceramic material composition according to claim 1, wherein the content of the sub-component Sc₂O₃ is in range of 0.45 mol to 1.00 mol.

3. The dielectric ceramic material composition according to claim 2, further comprising a secondary sub-component MgO.

4. The dielectric ceramic material composition according to claim 3, wherein a content of the secondary sub-component MgO per 100 mol of the main component BaTiO₃ is in range of 0.10 mol to 2.00 mol.

5. The dielectric ceramic material composition according to claim 2, further comprising a core-shell structure formed on grain structure.

6. The dielectric ceramic material composition according to claim 5, further comprising a secondary sub-component MgO.

7. The dielectric ceramic material composition according to claim 6, wherein a content of the secondary sub-component MgO per 100 mol of the main component BaTiO₃ is in range of 0.10 mol to 2.00 mol.

8. The dielectric ceramic material composition according to claim 5, wherein the content of the sub-component Sc₂O₃ is in range of 0.45 mol to 0.60 mol.

9. The dielectric ceramic material composition according to claim 8, further comprising a secondary sub-component MgO.

10. The dielectric ceramic material composition according to claim 9, wherein a content of the secondary sub-component MgO per 100 mol of the main component BaTiO₃ is in range of 0.10 mol to 2.00 mol.

11. The dielectric ceramic material composition according to claim 5, wherein the content of the sub-component Sc₂O₃ is in range of 0.60 mol to 1.00 mol.

12. The dielectric ceramic material composition according to claim 11, further comprising a secondary sub-component MgO.

13. The dielectric ceramic material composition according to claim 12, wherein a content of the secondary sub-component MgO per 100 mol of the main component BaTiO₃ is in range of 0.10 mol to 2.00 mol.

14. The dielectric ceramic material composition according to claim 1, wherein the content of the sub-component Sc₂O₃ is lower than 0.45 mol, and the dielectric ceramic material composition further comprises a secondary sub-component MgO.

15. The dielectric ceramic material composition according to claim 14, wherein a content of the secondary sub-component MgO per 100 mol of the main component BaTiO₃ is in range of 0.10 mol to 2.00 mol.

16. The dielectric ceramic material composition according to claim 15, wherein the content of the sub-component Sc₂O₃ is in range of 0.05 mol to 0.30 mol, and the content of the second sub-component MgO is in range of 0.10 mol to 1.00 mol.
